(19) United States
(12) Patent Application Publication
(10) Pub. No.: US 2026/0024684 A1
(43) Pub. Date: Jan. 22, 2026

(54) Heat Shrink Machine Fixture, Heat Shrink Machine and Method for Installing Heat Shrink Machine Fixture

(71) Applicant: Tyco Electronics (Shanghai) Co., Ltd., Shanghai (CN)

(72) Inventors: Zheng Gu, Shanghai (CN); Yiqun (Cham) Zhu, Shanghai (CN); Zhen Wang, Shanghai (CN); Tianyu (Bowen) Bao, Shanghai (CN)

(73) Assignee: Tyco Electronics (Shaghai) Co., Ltd., Shanghai (CN)

(21) Appl. No.: 19/273,210

(22) Filed: Jul. 18, 2025

(30) Foreign Application Priority Data
Jul. 18, 2024 (CN) 202410969464.7

(51) Int. Cl. H01B 13/012

(52) U.S. Cl. CPC H01B 13/01263

(57) ABSTRACT

A heat shrink machine fixture for clamping a wire harness product with a heat shrink tube includes a tray, a clamping component installed in the tray, and a plurality of installation components fixed to a bottom of the tray. The clamping component clamps and supports the wire harness product. The installation components are magnetically attracted to a frame of a heat shrink machine and detachably fix the heat shrink machine fixture to the frame of the heat shrink machine.

### CROSS-REFERENCE TO RELATED APPLICATION

This application claims the benefit of the filing date under 35 U.S.C. § 119 (a)-(d) of Chinese Patent Application No. 202410969464.7, filed on Jul. 18, 2024.

### FIELD OF THE INVENTION

The present invention relates to a heat shrink machine, specifically to a heat shrink machine fixture, a heat shrink machine comprising the heat shrink machine fixture, and a method for installing the heat shrink machine fixture.

### BACKGROUND OF THE INVENTION

A heat shrink machine is often used to heat shrink a heat shrink tube on a wire harness product onto the wire harness. In order to fix the wire harness product, a fixture for clamping the wire harness product is usually installed on the heat shrink machine. The fixture is usually fastened to the frame of the heat shrink machine by screws or bolts. This results in complex installation and disassembly operations for the fixture, requiring tightening or loosening multiple screws or bolts, which is very inconvenient to use.

In addition, different types of wire harness products require the use of different types of fixtures for clamping. However, the existing fixtures do not have model recognition features, which makes it easy for operators to mistakenly install a fixture that does not correspond to the model of the wire harness product to be clamped onto the frame of the heat shrink machine, which can affect the production quality of the wire harness product.

### SUMMARY OF THE INVENTION

A heat shrink machine fixture for clamping a wire harness product with a heat shrink tube includes a tray, a clamping component installed in the tray, and a plurality of installation components fixed to a bottom of the tray. The clamping component clamps and supports the wire harness product. The installation components are magnetically attracted to a frame of a heat shrink machine and detachably fix the heat shrink machine fixture to the frame of the heat shrink machine.

### BRIEF DESCRIPTION OF THE DRAWINGS

The invention will now be described by way of example with reference to the accompanying figures, of which:

FIG. 1 shows an illustrative perspective view of a heat shrink machine fixture according to an exemplary embodiment of the present invention when viewed from the top, wherein the heat shrink machine fixture has not yet been installed on the frame of the heat shrink machine;

FIG. 2 shows an illustrative perspective view of a heat shrink machine fixture according to an exemplary embodiment of the present invention when viewed from the top, wherein the heat shrink machine fixture has been installed on the frame of the heat shrink machine;

FIG. 3 shows an illustrative perspective view of a heat shrink machine fixture according to an exemplary embodiment of the present invention when viewed from the bottom, wherein the heat shrink machine fixture has not yet been installed on the frame of the heat shrink machine;

FIG. 4 shows an illustrative perspective view of a heat shrink machine fixture according to an exemplary embodiment of the present invention when viewed from the bottom, wherein the heat shrink machine fixture has been installed on the frame of the heat shrink machine;

FIG. 5 shows an illustrative perspective view of a heat shrink machine fixture according to an exemplary embodiment of the present invention;

FIG. 6 shows an illustrative exploded view of a heat shrink machine fixture according to an exemplary embodiment of the present invention; and

FIG. 7 shows an illustrative view of a wiring harness product according to an exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

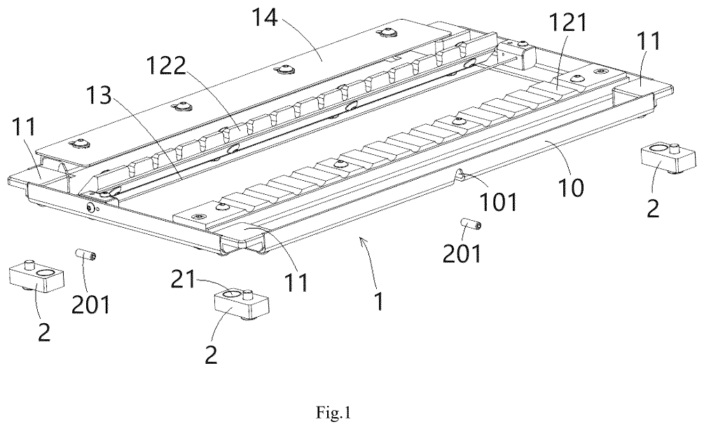

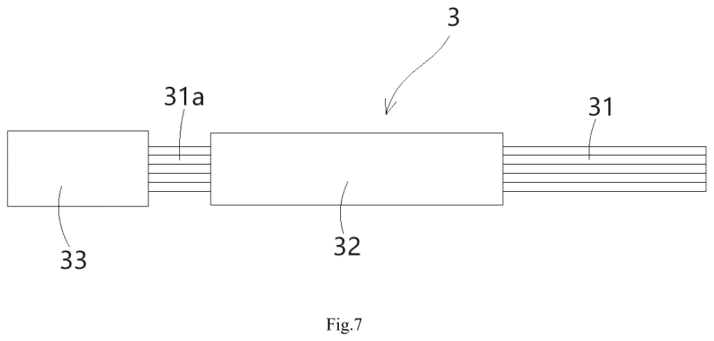

As shown in FIGS. 1 to 7, in an exemplary embodiment of the present invention, a heat shrink machine fixture 1 is disclosed. This heat shrink machine fixture 1 is used to clamp a plurality of wire harness products 3 having a plurality of heat shrink tubes 32.

The heat shrink machine fixture 1 includes a tray 10, a clamping component 12, and a plurality of installation components 11. The clamping component 12 is installed on the tray 10 for clamping and supporting the wire harness product 3. Multiple installation components 11 are fixed to the bottom of the tray 10. Multiple installation components 11 are magnetically attracted to a frame of the heat shrink machine, so that the heat shrink machine fixture 1 can be detachably fixed to the frame of the heat shrink machine through the installation components 11, achieving convenient and rapid installation and replacement of the heat shrink machine fixture 1.

In an exemplary embodiment of the present invention, the installation components 11 can be permanent magnets or multiple installation components 11 can be ferromagnetic objects that can be attracted by permanent magnets. In another exemplary embodiment of the present invention, some of the installation components 11 are permanent magnets, while others are ferromagnetic objects that can be attracted by the permanent magnets. In another exemplary embodiment of the present invention, multiple installation components 11 are iron components, cobalt components, nickel components, ferrite components, or carbon steel components that can be attracted by permanent magnets.

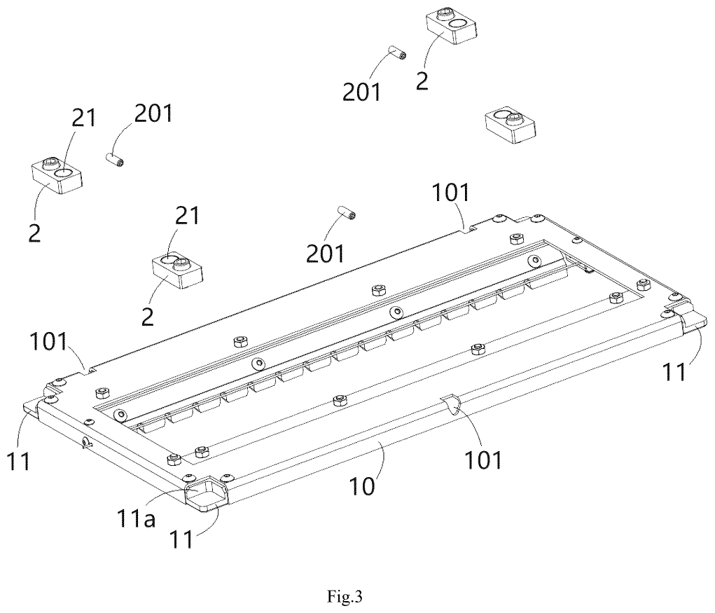

As shown in FIGS. 1 to 6, in the illustrated embodiment, the tray 10 has four corners, and the heat shrink machine fixture 1 includes four installation components 11, which are respectively fixed to the four corners of the tray 10. In the illustrated embodiment, as shown in FIG. 3, a positioning groove 11a is formed on the bottom of the installation component 11, which is suitable for mating with the installation block 2 fixed on the frame of the heat shrink machine. The installation component 11 magnetically attracts the fixing component 21 installed in the installation block 2.

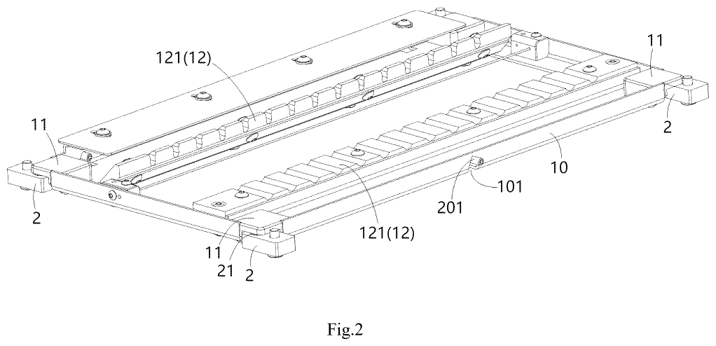

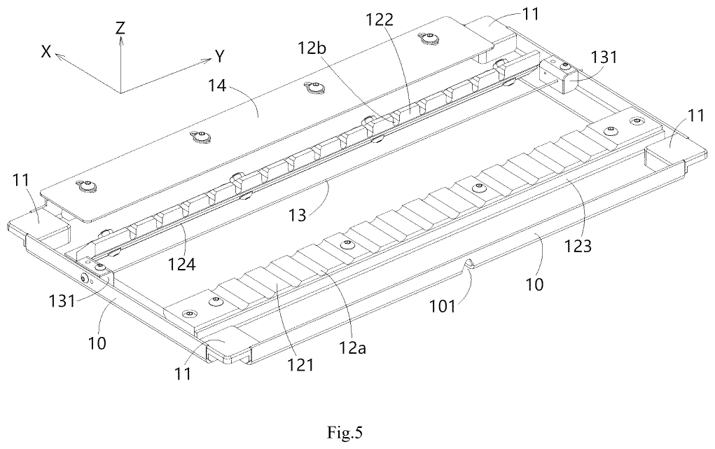

As shown in FIG. 2, in the illustrated embodiment, the clamping component 12 includes a first clamping block 121. The first clamping block 121 is installed on the tray 10 and extends between the two ends of the tray 10 along the longitudinal direction Y of the tray 10. Multiple first positioning slots 12a are formed on the first clamping block 121, extending along the transverse direction X of the tray 10 and arranged in a row along the longitudinal direction Y of the tray 10, as shown in FIG. 5. The multiple first positioning slots 12a are used to respectively position and hold the heat shrink tubes 32 of multiple wire harness products 3.

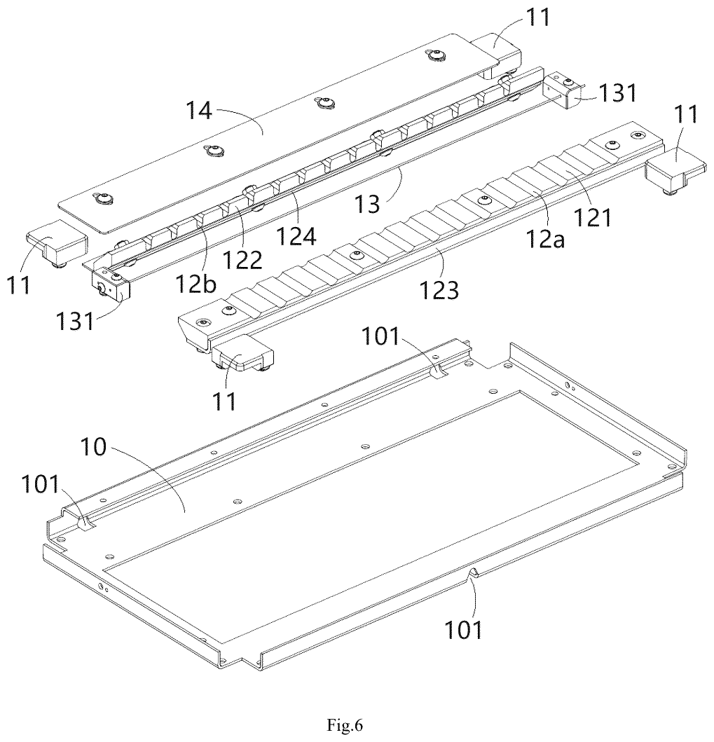

As shown in FIGS. 5 and 6, in the illustrated embodiment, the clamping component 12 further includes a first support frame 123, and the two ends of the first support frame 123 are respectively fixed to the two ends of the tray 10 for supporting the first clamping block 121. The first clamping block 121 is fixed to the first support frame 123 and installed onto the tray 10 through the first support frame 123.

As shown in FIGS. 1, 5, and 6, in the illustrated embodiment, the clamping component 12 includes a second clamping block 122, which is installed on the tray 10 and extends between the two ends of the tray 10 along the longitudinal direction Y of the tray 10. The first clamping block 121 and the second clamping block 122 are respectively located on both sides of the tray 10 and spaced opposite each other in the transverse direction X of the tray 10. Multiple second positioning slots 12b are formed on the second clamping block 122, extending along the transverse direction X of the tray 10 and arranged in a row along the longitudinal direction Y of the tray 10. The multiple second positioning slots 12b are used to respectively position and hold the wire harness ends 31a of multiple wire harness products 3.

As shown in FIGS. 5 and 6, in the illustrated embodiment, the clamping component 12 further includes a second support frame 124, and the two ends of the second support frame 124 are respectively fixed to the two ends of the tray 10 for supporting the second clamping block 122. The second clamping block 122 is fixed to the second support frame 124 and installed onto the tray 10 through the second support frame 124.

As shown in FIGS. 5 and 6, in the illustrated embodiment, the heat shrink machine fixture further includes a positioning wire 13, and the two ends of the positioning wire 13 are fixed to the two ends of the tray 10 and extend along the longitudinal direction Y of the tray 10. The positioning wire 13 is located between the first clamping block 121 and the second clamping block 122, and is used to align with the positioning feature on the wiring harness product 3, serving as a positioning reference for the wiring harness product 3. In the illustrated embodiment, the positioning wire 13 can be a steel wire rope.

As shown in FIGS. 5 and 6, in the illustrated embodiment, the heat shrink machine fixture further includes a pair of fixing blocks 131, which are respectively fixed to both ends of the tray 10. The two ends of positioning wire 13 are respectively fixed to the pair of fixing blocks 131 and fixed to the two ends of tray 10 through the pair of fixing blocks 131.

As shown in FIGS. 1, 5, and 6, in the illustrated embodiment, the heat shrink machine fixture further includes a shielding plate 14, which is installed on one side of the tray 10 and close to the second clamping block 122, for shielding the end connector 33 of the wire harness product 3 to prevent the end connector 33 from being affected by thermal radiation.

As shown in FIGS. 1 to 6, in the illustrated embodiment, positioning slots 101 suitable for mating with the positioning pins 201 on the frame of the heat shrink machine are formed on both sides of the tray 10, and the positioning slot 101 on one side of the tray 10 is asymmetric with the positioning slot 101 on the other side of the tray 10 to prevent the heat shrink machine fixture 1 from being installed on the frame of the heat shrink machine in the wrong orientation. In the illustrated embodiment, the positioning slot 101 is V-shaped and the number of positioning slots 101 on one side of the tray 10 is different from the number of positioning slots 101 on the other side of the tray 10.

In an embodiment, an identification code for identifying the model of the heat shrink machine fixture 1 is provided on the heat shrink machine fixture 1 to prevent a heat shrink machine fixture 1 that does not correspond to the model of the wire harness product 3 to be clamped from being installed onto the frame of the heat shrink machine. In an embodiment, the identification code is set on the exposed surface of the installation part 11, and the identification code is a barcode or QR code.

In another exemplary embodiment of the present invention, a heat shrink machine is also disclosed. The heat shrink machine includes a frame, multiple fixing components 21, and a heat shrink machine fixture 1. Multiple fixing components 21 are fixedly installed on the frame. The heat shrink machine fixture 1 is installed onto the frame. The multiple installation components 11 of the heat shrink machine fixture 1 and the multiple fixing components 21 on the frame are magnetically attracted together, so that the heat shrink machine fixture 1 is detachably fixed to the frame of the heat shrink machine.

In an exemplary embodiment of the present invention, multiple fixing components 21 are permanent magnets or multiple fixing components 21 are ferromagnetic objects that can be attracted by permanent magnets. In another exemplary embodiment of the present invention, some of the fixing components 21 are permanent magnets, while others are ferromagnetic objects that can be attracted by the permanent magnets.

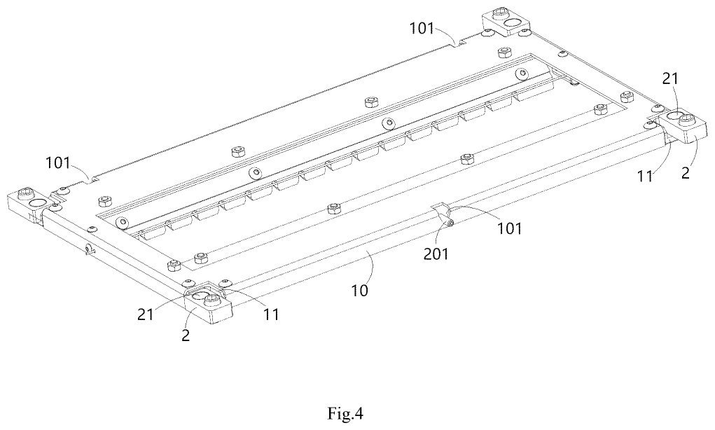

As shown in FIGS. 2 and 4, in the illustrated embodiment, the heat shrink machine further comprises multiple installation blocks 2, which are fixed to the frame and respectively formed with installation holes. The fixing component 21 is installed into the installation hole of the installation block 2 in an interference fit manner and fixed to the frame through the installation block 2.

As shown in FIGS. 1 to 4, in the illustrated embodiment, the heat shrink machine further includes multiple positioning pins 201, which are fixed to the frame and used to mate with multiple positioning slots 101 on the tray 10 to position the heat shrink machine fixture 1 and prevent the heat shrink machine fixture 1 from being installed on the frame of the heat shrink machine in the wrong orientation.

In another exemplary embodiment of the present invention, a method for installing a heat shrink machine fixture is also disclosed. The installation method of the heat shrink machine fixture includes the following steps:
S10: providing the aforementioned heat shrink machine fixture 1;
S20: reading the identification code on the heat shrink machine fixture 1 to identify the model of the heat shrink machine fixture 1;
S30: determining whether the model of the heat shrink machine fixture 1 corresponds to the model of the wire harness product 3 to be clamped; and
S40: if it is determined that the model of the heat shrink machine fixture 1 does not match the model of the wire harness product 3 to be clamped, an error alarm is issued and the heat shrink machine cannot be started.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A heat shrink machine fixture for clamping a wire harness product with a heat shrink tube, comprising:
a tray;
a clamping component installed in the tray, the clamping component clamping and supporting the wire harness product; and
a plurality of installation components fixed to a bottom of the tray, the installation components are magnetically attracted to a frame of a heat shrink machine and detachably fix the heat shrink machine fixture to the frame of the heat shrink machine.

2. The heat shrink machine fixture according to claim 1, wherein:
the installation components are permanent magnets or ferromagnetic objects that can be attracted by permanent magnets; or
some of the installation components are permanent magnets, and others of the installation components are ferromagnetic objects that can be attracted by permanent magnets.

3. The heat shrink machine fixture according to claim 1, wherein the tray has four corners and the installation components include four installation components respectively fixed to the four corners of the tray.

4. The heat shrink machine fixture according to claim 1, wherein a positioning groove is formed on a bottom of each of the installation components, the positioning groove on each of the installation components mates with one of a plurality of installation blocks fixed on the frame of the heat shrink machine, the installation components are magnetically attached to a fixing component installed in each of the installation blocks.

5. The heat shrink machine fixture according to claim 1, wherein the clamping component includes a first clamping block installed in the tray and extending between a pair of ends of the tray along a longitudinal direction of the tray, a plurality of first positioning slots are formed on the first clamping block, the first positioning slots extend along a transverse direction of the tray and are arranged in a row along the longitudinal direction of the tray, the first positioning slots each respectively position and hold the heat shrink tube of one wire harness product.

6. The heat shrink machine fixture according to claim 5, wherein the clamping component includes a first support frame supporting the first clamping block, a pair of ends of the first support frame are respectively fixed to the ends of the tray, the first clamping block is fixed to the first support frame and installed onto the tray through the first support frame.

7. The heat shrink machine fixture according to claim 5, wherein the clamping component includes a second clamping block installed in the tray and extending between the ends of the tray along the longitudinal direction of the tray, the first clamping block and the second clamping block are respectively adjacent to a pair of sides of the tray and spaced opposite each other in the transverse direction of the tray, a plurality of second positioning slots are formed on the second clamping block, the second positioning slots extend along the transverse direction of the tray and are arranged in a row in the longitudinal direction of the tray, the second positioning slots each respectively position and hold a wire harness ends of one wire harness product.

8. The heat shrink machine fixture according to claim 7, wherein the clamping component includes a second support frame supporting the second clamping block, a pair of ends of the second support frame are respectively fixed to the ends of the tray, the second clamping block is fixed to the second support frame and installed onto the tray through the second support frame.

9. The heat shrink machine fixture according to claim 7, further comprising a positioning wire, a pair of ends of the positioning wire are fixed to the ends of the tray and the positioning wire extends along the longitudinal direction of the tray, the positioning wire is located between the first clamping block and the second clamping block and aligns with a positioning feature on the wiring harness product to serve as a positioning reference for the wiring harness product.

10. The heat shrink machine fixture according to claim 9, further comprising a pair of fixing blocks respectively fixed to the ends of the tray, the ends of the positioning wire are respectively fixed to the pair of fixing blocks and fixed to the ends of the tray through the pair of fixing blocks.

11. The heat shrink machine fixture according to claim 7, further comprising a shielding plate installed on one of the sides of the tray adjacent to the second clamping block, the shielding plate shields an end connector of the wire harness product to prevent the end connector from being affected by thermal radiation.

12. The heat shrink machine fixture according to claim 1, wherein a plurality of positioning slots are respectively formed on a pair of sides of the tray and respectively mate with a plurality of positioning pins on the frame of the heat shrink machine, at least one of the positioning slots on one of the sides of the tray is asymmetric with another of the positioning slots on the other of the sides of the tray to prevent the heat shrink machine fixture from being installed on the frame of the heat shrink machine in a wrong orientation.

13. The heat shrink machine fixture according to claim 12, wherein the positioning slots are each V-shaped and the number of positioning slots on one side of the tray is different from the number of positioning slots on the other side of the tray.

14. The heat shrink machine fixture according to claim 1, wherein an identification code for identifying a model of the heat shrink machine fixture is provided on the heat shrink machine fixture to prevent the heat shrink machine fixture that does not correspond to a model of the wire harness product from being installed onto the frame of the heat shrink machine.

15. The heat shrink machine fixture according to claim 14, wherein the identification code is set on an exposed surface of one of the installation components, the identification code is a barcode or a QR code.

16. A heat shrink machine, comprising:
a frame;
a plurality of fixing components fixedly installed on the frame; and
a heat shrink machine fixture installed on the frame, the heat shrink machine fixture includes a tray, a clamping component installed in the tray, and a plurality of installation components fixed to a bottom of the tray, the installation components are magnetically attracted to the fixing components and detachably fix the heat shrink machine fixture to the frame.

17. The heat shrink machine according to claim 16, wherein:
the fixing components are permanent magnets or ferromagnetic objects that can be attracted by permanent magnets; or
some of the fixing components are permanent magnets, and others of the fixing components are ferromagnetic objects that can be attracted by permanent magnets.

18. The heat shrink machine according to claim 16, further comprising a plurality of installation blocks fixed to the frame and each having an installation hole, the fixing components are each installed into the installation hole of one of the installation blocks in an interference fit manner and are fixed to the frame through the installation blocks.

19. The heat shrink machine according to claim 16, further comprising a plurality of positioning pins fixed to the frame and mating with a plurality of positioning slots on the tray to position the heat shrink machine fixture and prevent the heat shrink machine fixture from being installed in a wrong orientation on the frame.

20. A method for installing a heat shrink machine fixture, comprising:
providing a heat shrink machine fixture including a tray, a clamping component installed in the tray, and a plurality of installation components fixed to a bottom of the tray;
reading an identification code on the heat shrink machine fixture to identify a model of the heat shrink machine fixture;
determining whether the model of the heat shrink machine fixture corresponds to a model of a wire harness product to be clamped by the clamping component; and
issuing an error alarm and preventing starting of the heat shrink machine if it is determined that the model of the heat shrink machine fixture does not match the model of the wire harness product.
